(19) United States
(12) Patent Application Publication
(10) Pub. No.: US 2017/0134726 A1
(43) Pub. Date: May 11, 2017

(54) TEMPLATE-MATCHING-BASED METHOD AND APPARATUS FOR ENCODING AND DECODING INTRA PICTURE

(71) Applicant: INTELLECTUAL DISCOVERY CO., LTD., Seoul (KR)

(72) Inventors: Dong Gyu SIM, Seoul (KR); Hyun Ho JO, Seoul (KR)

(73) Assignee: INTELLECTUAL DISCOVERY CO., LTD., Seoul (KR)

(21) Appl. No.: 15/127,465

(22) PCT Filed: Jan. 19, 2015
(86) PCT No.: PCT/KR2015/000507

§ 371 Date: Sep. 20, 2016

(30) Foreign Application Priority Data
Mar. 31, 2014 (KR) 10-2014-0037577

(51) Int. Cl. H04N 19/11; H04N 19/176

(52) U.S. Cl. CPC H04N 19/11; H04N 19/176

(57) ABSTRACT

An apparatus and a method for decoding an image are disclosed. More specifically, the apparatus for decoding an image comprises a template matching prediction unit for determining whether to generate a template-matching-based prediction signal for a current CU by using flag information for indicating whether the current CU is encoded in a template-matching-based prediction mode, wherein the flag information is used when a size of the current CU satisfies a range condition for the minimum size and the maximum size of the CU to be encoded in the prediction mode.

### TECHNICAL FIELD

The present invention generally relates to video processing technology and, more particularly, to a method for encoding/decoding an intra-picture block in a template matching-based prediction mode when video is encoded/decoded.

### BACKGROUND ART

Recently, as demand for high-resolution and high-video quality has increased, high-efficiency video compression technology for next-generation video services has been required. In response to such market demand, the Moving Picture Experts Group (MPEG) and the Video Coding Expert Group (VCEG) organized the Joint Collaborative Team on Video Coding (JCT-VC) in 2010, and thereafter started to develop next-generation video standard technology, known as High Efficiency Video Coding (HEVC). The development of HEVC version1 standard technology was completed in January 2013, and HEVC enables compression efficiency to be improved by about 50% based on the same subjective video quality, compared to H.264/AVC High Profile, which was previously known to exhibit the highest compression efficiency among existing video compression standards.

Recently, since the standardization of HEVC version1, JCT-VC has developed range extension as extended standard technology for supporting bit depths up to color formats such as 4:0:0, 4:2:2, and 4:4:4 and a maximum of 16 bits. Further, JCT-VC published Joint Call for Proposals in January 2014 in order to develop video compression technology for effectively encoding screen content based on HEVC.

Meanwhile, Korean Patent Application Publication No. 2010-0132961 (entitled “METHOD AND APPARATUS FOR ENCODING AND DECODING TO IMAGE USING TEMPLATE MATCHING”) discloses technology including the steps of determining a template for an encoding target block, determining a matching-based search target image on which a matching-based search is to be performed using the determined template, determining an optimal predicted block using the determined matching-based search target image and the determined template, and generating a residual block using the optimal predicted block and the encoding target block.

### DISCLOSURE

### Technical Problem

An object of some embodiments of the present invention is to provide an encoding/decoding apparatus, which can perform template matching-based prediction when a predetermined condition is satisfied by imposing restrictions on the range of execution of template matching-based prediction.

Another object of some embodiments of the present invention is to provide an apparatus and method, which enable skip mode technology to be used when some intra-picture blocks are encoded/decoded in a template matching-based prediction mode.

A further object of some embodiments of the present invention is to provide an apparatus and method, which can determine boundary strength in a deblocking filtering procedure when template matching-based prediction and non-template matching-based prediction are used together.

Yet another object of some embodiments of the present invention is to provide an apparatus and method, which can simultaneously perform a template matching-based prediction mode and a non-template matching-based prediction mode in an arbitrary coding unit.

However, the technical objects to be accomplished by the present embodiments are not limited to the above-described technical objects, and other technical objects may be present.

### Technical Solution

In order to accomplish the above objects, a video decoding apparatus according to an embodiment of the present invention includes a template matching prediction unit for determining whether to generate a template matching-based predicted signal for a current Coding Unit (CU) using flag information that indicates whether the current CU has been encoded in a template matching-based prediction mode, wherein the flag information is used when a size of the current CU satisfies a range condition for minimum and maximum sizes of each CU to be encoded in the prediction mode.

In order to accomplish the above objects, a video decoding apparatus according to another embodiment of the present invention includes a template matching prediction unit for determining whether to perform a template matching-based prediction mode on a plurality of Coding Tree Units (CTUs) that are spatially adjacent to each other, using region flag information for the CTUs, and for determining whether to generate a template matching-based predicted signal, using additional flag information that indicates whether each CU in a CTU determined to perform the prediction mode has been encoded in the template matching-based prediction mode.

Further, a video decoding apparatus according to a further embodiment of the present invention includes a template matching prediction unit for determining, using skip flag information, whether to generate a template matching-based predicted signal for a current CU, wherein the skip flag information is used when any one of a picture, a slice, and a slice segment that includes the current CU, is intra coded, when the current CU is encoded in a template matching-based prediction mode, when a block vector for the current CU is identical to a block vector for a neighboring region spatially adjacent to the current CU, and when a residual signal for the current CU is absent.

Furthermore, a video decoding apparatus according to still another embodiment of the present invention includes a template matching prediction unit for determining whether to generate a template matching-based predicted signal for a current CU, using flag information indicating whether the current CU has been encoded in a template matching-based prediction mode, and for setting a boundary strength for deblocking filtering at an edge boundary of the current CU, wherein a boundary strength between the current CU and each neighboring CU adjacent to the current CU with respect to the edge boundary is set differently depending on prediction modes, residual signals, and block vectors for the current CU and the neighboring CU.

Furthermore, a video decoding method according to an embodiment of the present invention includes, when a size of a current CU satisfies a range condition for minimum and maximum sizes of each CU to be encoded in a template matching-based prediction mode, determining whether to generate a template matching-based predicted signal for the current CU, using flag information indicating whether the current CU has been encoded in the prediction mode.

Furthermore, a video decoding method according to another embodiment of the present invention includes determining whether to perform a template matching-based prediction mode on a plurality of Coding Tree Units (CTUs) that are spatially adjacent to each other, using region flag information for the CTUs; determining whether to generate a template matching-based predicted signal, using additional flag information that indicates whether each CU in a CTU determined to perform the prediction mode has been encoded in the template matching-based prediction mode.

Furthermore, a video decoding method according to a further embodiment of the present invention includes determining, using skip flag information, whether to generate a template matching-based predicted signal for a current CU when any one of a picture, a slice, and a slice segment that includes the current CU, is intra coded, when the current CU is encoded in a template matching-based prediction mode, when a block vector for the current CU is identical to a block vector for a neighboring region spatially adjacent to the current CU, and when a residual signal for the current CU is absent.

Furthermore, a video decoding method according to still another embodiment of the present invention includes a video decoding method includes determining whether to generate a template matching-based predicted signal for a current CU, using flag information indicating whether the current CU has been encoded in a template matching-based prediction mode; and setting a boundary strength for deblocking filtering at an edge boundary of the current CU, wherein a boundary strength between the current CU and each neighboring CU adjacent to the current CU with respect to the edge boundary is set differently depending on prediction modes, residual signals, and block vectors for the current CU and the neighboring CU.

### Advantageous Effects

In accordance with the technical solution of the present invention, when a predetermined condition related to the size of a coding unit is satisfied, template matching-based decoding is performed from a previously decoded area in a slice, a slice segment, or a picture, so that the amount of related bit data to be transmitted is suitably controlled, thus optimizing encoding/decoding efficiency. Further, since restrictions are imposed on the range of performance of template matching-based prediction in high level syntax or on the size of the coding unit to be encoded in a template matching-based prediction mode, the overall encoding/decoding rate may be improved.

Further, in accordance with the above-described embodiments, region flag information is used, and may then be usefully exploited for the improvement of coding efficiency in the fields of screen content in which a subtitle region and a video region are separated.

Furthermore, in accordance with the above-described embodiments, a skip mode, which is used in existing inter-prediction-based prediction mode, is applied to a template matching-based prediction mode, thus improving video encoding/decoding efficiency.

Furthermore, in accordance with the above-described embodiments, the boundary strength between the current coding unit and a neighboring coding unit is set differently depending on a prediction mode, a residual signal, and a block vector, thus enabling deblocking filtering to be more efficiently performed.

### DESCRIPTION OF DRAWINGS

FIG. 1 is a block showing the overall configuration of a video decoding apparatus according to an embodiment of the present invention;

FIG. 2a is a diagram illustrating template matching-based predictive encoding/decoding performed in a Coding Unit (CU) in a Coding Tree Unit (CTU);

FIG. 2b is a diagram illustrating syntax elements related to whether to use template matching, described in a CU;

FIG. 3a is a diagram illustrating syntax elements described in a picture parameter set and a coding unit level;

FIG. 3b is a block diagram showing a detailed configuration for determining the size of a CU in a template matching prediction unit;

FIG. 4a is a block diagram showing the detailed configuration of a video encoding apparatus for performing encoding in a template matching-based prediction mode;

FIG. 4b is a block diagram showing the detailed configuration of a video decoding apparatus for performing decoding in a template matching-based prediction mode;

FIG. 5a is a diagram illustrating syntax elements related to whether to use template matching when the size of a CU is identical to the minimum size of the CU;

FIG. 5b is a diagram showing in brief the operation of a video decoding apparatus for performing decoding on each CU or for each Prediction Unit (PU) according to the size of a CU;

FIG. 6 is a diagram illustrating an example in which a prediction unit encoded in a template matching-based prediction mode, among prediction units in a CU, is decoded first when the size of the CU is identical to the minimum size of the CU;

FIG. 7 is a diagram illustrating an example in which a prediction unit encoded in an intra-prediction mode is decoded with reference to an area, previously decoded in the template matching-based prediction mode, in the CU shown in FIG. 6;

FIG. 8A is a diagram illustrating a structure for describing whether to perform template matching-based predictive decoding in units of rows of a CTU;

FIG. 8B is a diagram illustrating a structure for describing whether to perform template matching-based predictive decoding in units of columns of a CTU;

FIG. 9a is a diagram illustrating a structure for describing whether to perform template matching-based predictive decoding based on the start position of a CTU and the number of consecutive CTUs;

FIG. 9B is a diagram illustrating a structure for describing whether to perform template matching-based predictive decoding based on an arbitrary rectangular region composed of CTUs;

FIG. 10a is a diagram illustrating an algorithm for encoding the current CU in a skip mode;

FIG. 10b is a block diagram showing a detailed configuration for encoding the current CU in a skip mode;

FIG. 10c is a block diagram showing a detailed configuration for decoding the current CU in a skip mode;

FIG. 11 is a diagram showing an algorithm for setting a boundary strength to perform deblocking filtering at an edge boundary according to an example;

FIG. 12 is a diagram showing an algorithm for setting a boundary strength to perform deblocking filtering at an edge boundary according to another example;

FIG. 13 is a flowchart showing a video decoding method according to an embodiment of the present invention;

FIG. 14 is a flowchart showing a video decoding method according to another embodiment of the present invention;

FIG. 15 is a flowchart showing a video decoding method according to a further embodiment of the present invention; and

FIG. 16 is a flowchart showing a video decoding method according to still another embodiment of the present invention.

### BEST MODE

Embodiments of the present invention are described with reference to the accompanying drawings in order to describe the present invention in detail so that those having ordinary knowledge in the technical field to which the present invention pertains can easily practice the present invention. However, the present invention may be implemented in various forms, and is not limited by the following embodiments. In the drawings, the illustration of components that are not directly related to the present invention will be omitted, for clear description of the present invention, and the same reference numerals are used to designate the same or similar elements throughout the drawings.

Further, throughout the entire specification, it should be understood that a representation indicating that a first component is “connected” to a second component may include the case where the first component is electrically connected to the second component with some other component interposed therebetween, as well as the case where the first component is “directly connected” to the second component. Furthermore, it should be understood that a representation indicating that a first component “includes” a second component means that other components may be further included, without excluding the possibility that other components will be added, unless a description to the contrary is specifically pointed out in context.

Throughout the present specification, a representation indicating that a first component “includes” a second component means that other components may be further included, without excluding the possibility that other components will be added, unless a description to the contrary is specifically pointed out in context. The term “step of performing ˜” or “step of ˜” used throughout the present specification does not mean the “step for ˜”.

Terms such as “first” and “second” may be used to describe various elements, but the elements are not restricted by the terms. The terms are used only to distinguish one element from the other element.

Furthermore, element units described in the embodiments of the present invention are independently shown in order to indicate different and characteristic functions, but this does not mean that each of the element units is formed of a separate piece of hardware or software. That is, the element units are arranged and included for convenience of description, and at least two of the element units may form one element unit or one element unit may be divided into a plurality of element units to perform their own functions. An embodiment in which the element units are integrated and an embodiment in which the element units are separated are included in the scope of the present invention, unless it departs from the essence of the present invention.

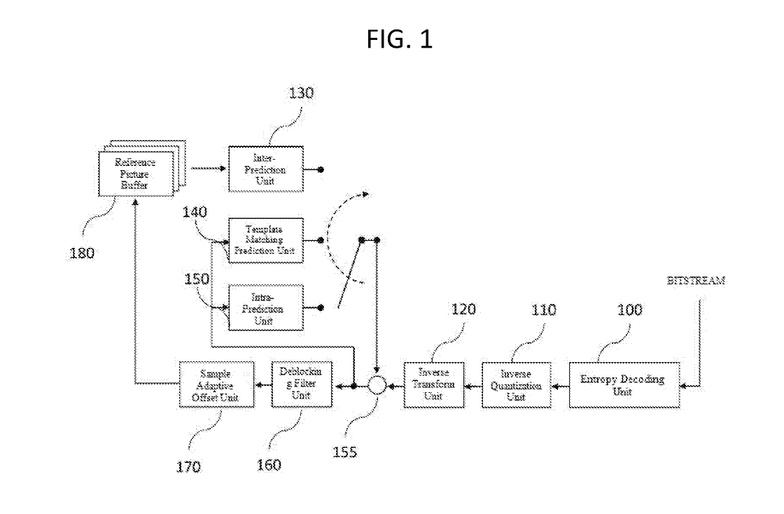

Hereinafter, a video decoding apparatus proposed in the present invention will be described in detail with reference to FIG. 1. FIG. 1 is a block diagram showing the overall configuration of a video decoding apparatus according to an embodiment of the present invention.

For reference, since a video encoding process and a video decoding process may correspond to each other in many aspects, those skilled in the art may easily understand the video encoding process with reference to the video decoding process, which will be described later.

Referring to FIG. 1, the video decoding apparatus proposed in the present invention may include an entropy decoding unit 100, an inverse quantization unit 110, an inverse transform unit 120, an inter-prediction unit 130, a template matching prediction unit 140, an intra-prediction unit 150, an adder 155, a deblocking filter unit 160, a sample adaptive offset (SAO) unit 170, and a reference image (picture) buffer 180.

The entropy decoding unit 100 decodes an input bitstream and outputs decoding information, such as syntax elements and quantized coefficients.

Here, the prediction mode information included in the syntax elements is information indicating the prediction mode in which each Coding Unit (CU) has been encoded or is to be decoded. In the present invention, the prediction mode corresponding to any one of intra prediction, inter prediction, and template matching-based prediction may be performed.

The inverse quantization unit 110 and the inverse transform unit 120 may receive quantized coefficients, sequentially perform inverse quantization and inverse transform, and then output a residual signal.

The inter-prediction unit 130 generates an inter prediction-based predicted signal by performing motion compensation using motion vectors transmitted from the encoding apparatus and reconstructed images stored in the reconstructed picture buffer 180.

The intra-prediction unit 150 generates an intra prediction-based predicted signal by performing spatial prediction using pixel values of previously decoded neighboring blocks that are adjacent to the current block to be decoded.

The template matching prediction unit 140 generates an intra block copy-based predicted signal by performing template matching-based compensation from a previously decoded area in the current picture or slice being decoded. The template matching-based compensation is performed on a per-block basis, similar to inter prediction, and information about motion vectors for template matching (hereinafter referred to as ‘block vectors’) is described in syntax elements.

The predicted signal output through the inter-prediction unit 130, the template matching prediction unit 140 or the intra-prediction unit 150 is added to a residual signal by the adder 155, and thus a reconstructed signal, generated on a per-block basis, includes a reconstructed image.

The reconstructed block-unit image is transferred to the deblocking filter unit 160 and to the SAO unit 170. A reconstructed picture to which deblocking filtering and sample adaptive offset (SAO) are applied is stored in the reconstructed picture buffer 180, and may be used as a reference picture in the inter-prediction unit 130.

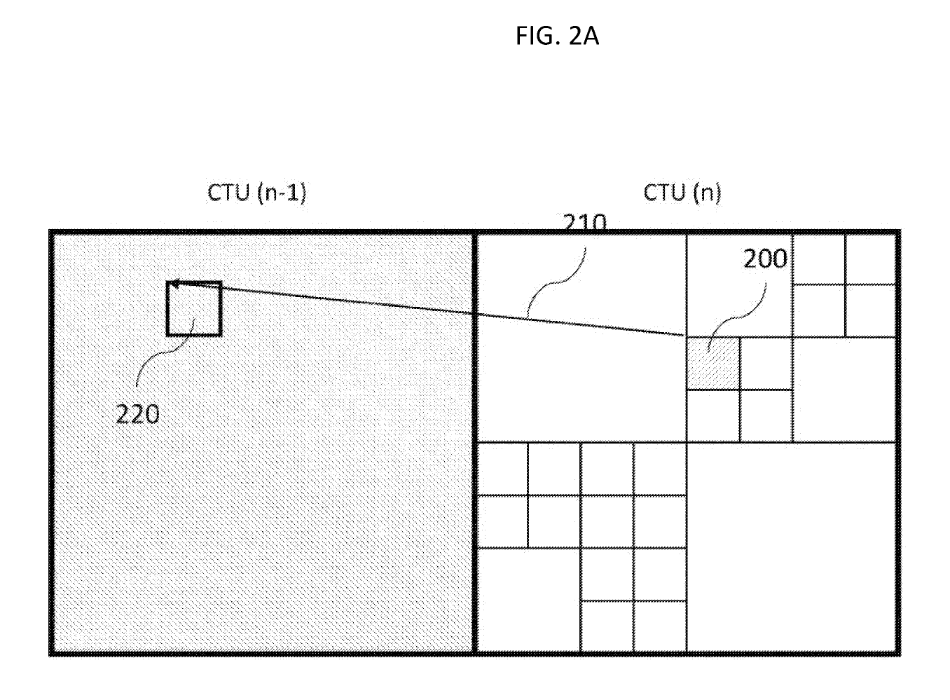

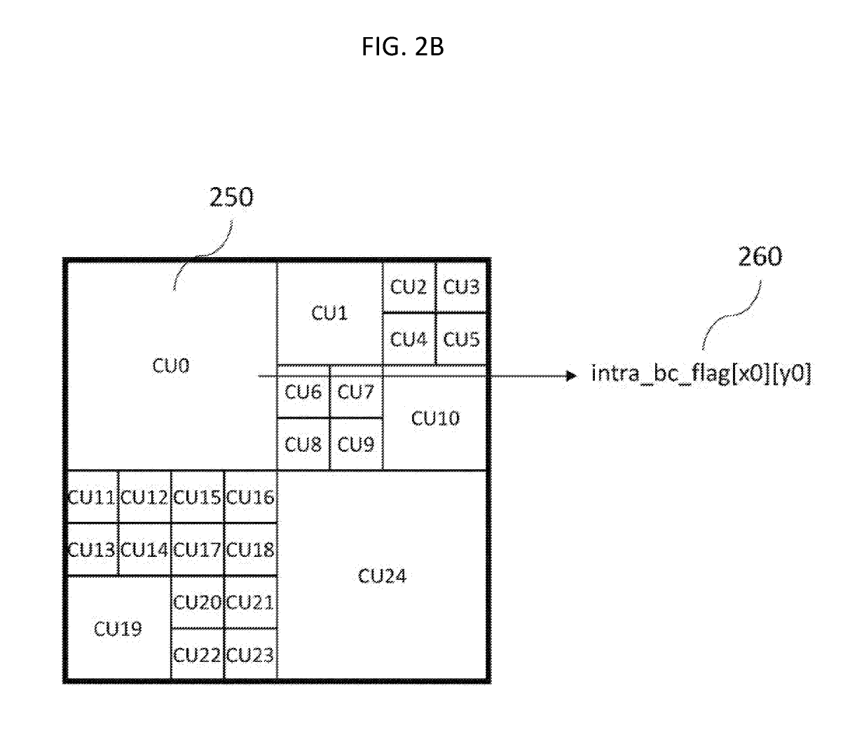

FIG. 2a is a diagram illustrating template matching-based predictive encoding/decoding performed in a CU in a Coding Tree Unit (CTU).

Referring to FIG. 2a, the current CTU (CTU(n)), including a CU 200 to be currently encoded/decoded, and the previous CTU (CTU(n−1)), including a previously encoded/decoded area, are depicted. When template matching-based predictive encoding/decoding is performed on the CU 200, template matching with the previously reconstructed area in the current picture, slice, or slice segment is performed.

Information about the block on which template matching is performed is represented by a block vector, which is the position information 210 of the corresponding predicted block 220. After such a block vector is predicted from the vector of a neighboring block, only the difference value therebetween may be described.

FIG. 2b is a diagram illustrating a syntax element related to whether to use template matching described in a unit, such as a CU.

Referring to FIG. 2b, when the current CU 250 is encoded in a template matching-based prediction mode, information about the encoding may be described in the form of a CU-based flag 260. When the value of intra_bc_flag of the current CU 250 is 1, it means that the corresponding CU may be encoded using template matching-based prediction, and when the value of the intra_bc_flag of the current CU 250 is 0, the CU may be encoded in an intra prediction or inter prediction-based prediction mode.

Meanwhile, the video decoding apparatus according to the embodiment of the present invention may include a template matching prediction unit.

The template matching prediction unit may receive prediction mode information extracted from a bitstream, check flag information indicating whether the current CU (CU to be decoded) has been encoded in a template matching-based prediction mode, and determine whether to generate a template matching-based predicted signal for the current CU using the corresponding flag information. Further, the template matching prediction unit may generate a template matching-based predicted signal for the current CU, which has been encoded in the template matching-based prediction mode. Furthermore, the template matching prediction unit may generate a template matching-based predicted signal from a previously decoded area in any one of a picture, a slice, and a slice segment in which the current CU is included.

Here, the flag information is described in syntax for the current CU, and may be used when the size of the current CU satisfies a range condition for the minimum size and maximum size of a CU required for encoding in a template matching-based prediction mode.

Here, information about the range condition may be described in a sequence parameter set, a picture parameter set or a slice header, which corresponds to high-level syntax. In this way, in the high-level syntax, when restrictions are imposed on the execution range of template matching-based prediction or on the size of the CU to be encoded in a template matching-based prediction mode, the number of bits for a syntax element related to template matching-based prediction may be reduced. Further, since a syntax element related to the template matching-based prediction is encoded on a per-CU basis, the overall encoding rate may be improved owing to the reduction of the number of bits. Furthermore, when the limited range condition is satisfied, the syntax element related to template matching-based prediction is decoded, and thus the overall decoding rate may be improved.

In a decoding process related to typical template matching-based prediction, when the value of the intra_block_copy_enabled_flag syntax element described in a sequence parameter set is 0, the current CU is decoded via intra prediction or inter prediction. Further, when the value of the corresponding syntax element is 1, the current CU is decoded via template matching-based prediction. Since the existing scheme does not define the above-described range condition, syntax elements related to template matching-based prediction are encoded/decoded for respective CUs, regardless of whether the range condition is satisfied.

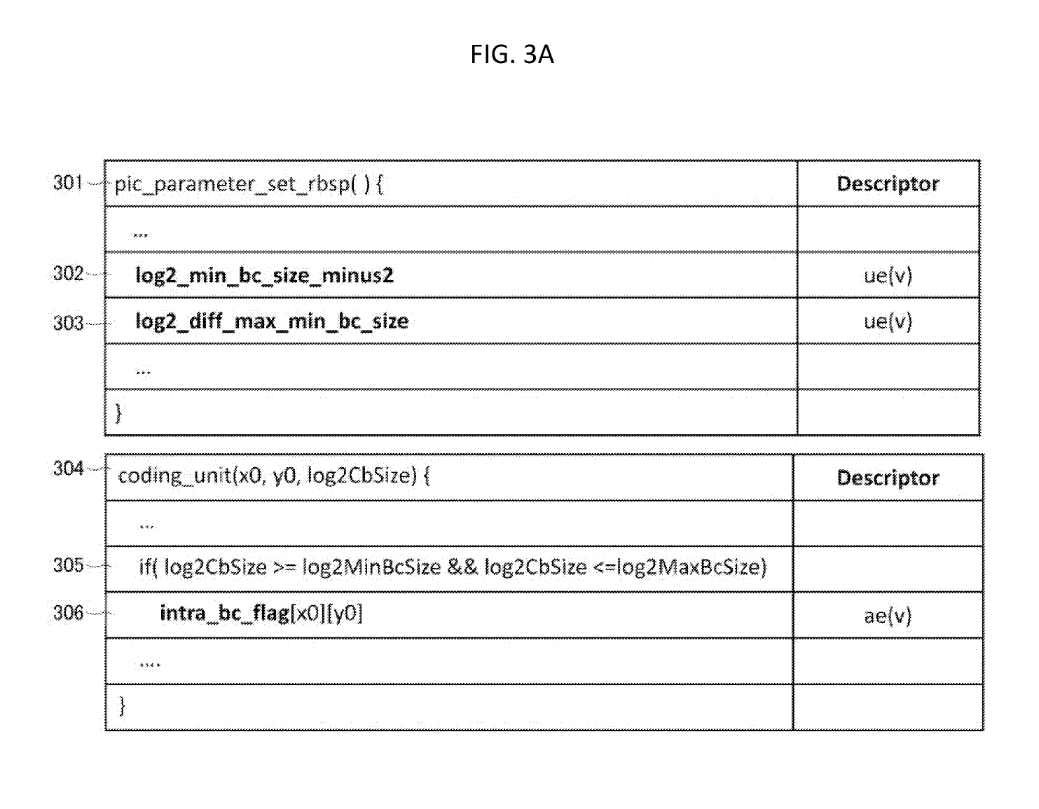

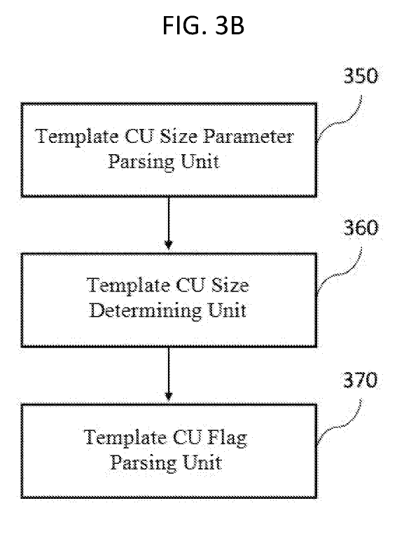

FIG. 3a is a diagram illustrating syntax elements described in a picture parameter set and a coding unit level.

Referring to FIG. 3a, whether to perform template matching-based predictive encoding in a coding unit level is described using the flag “intra_bc_flag” 306. In particular, in accordance with an embodiment of the present invention, in order to more efficiently represent the corresponding flag bit, the size information of a CU that enables template matching may be described in high-level syntax such as a sequence parameter set, a picture parameter set or a slice header.

That is, information about the range condition for the minimum size and the maximum size of CUs to be encoded in a template matching-based prediction mode may be included in a sequence parameter set for a sequence that includes the current CU, a picture parameter set for a picture group or a picture that includes the current CU, or a slice header for a slice or a slice segment that includes the current CU.

As in the case of the example shown in FIG. 3a, the syntax element “log 2_min_bc_size_minus2” 302 and the syntax element “log 2_diff_max_min_bc_size” 303 may be additionally described in a picture parameter set 301 corresponding to the high-level syntax.

The syntax element “log 2_min_bc_size_minus2” 302 denotes a syntax element describing the minimum size of a CU by which template matching-based predictive encoding may be performed, in a slice segment referring to the corresponding picture parameter set 301.

The syntax element “log 2_diff_max_min_bc_size” 303 denotes a syntax element related to the difference between the minimum size and the maximum size of the CU by which template matching-based predictive encoding may be performed. Although the syntax element indicating the maximum size of the CU by which template matching-based predictive encoding may be performed may be directly described, the syntax element 301 for such a difference value, instead of a syntax element indicating the maximum size, is described, thus reducing the number of bits included in the picture parameter set 301.

In addition, unless the syntax elements 302 and 303 are explicitly described, the minimum size of the CU, by which template matching-based predictive encoding may be performed, is identical to the minimum size of the CU of the current slice, and the maximum size of the CU, by which template matching-based predictive encoding may be performed, may be identical to the maximum size of the CU of the current slice. That is, when the size of the current CU satisfies the range condition for the minimum and maximum sizes of a slice including the current CU, the template matching prediction unit may determine whether to generate a template matching-based predicted signal for the current CU using the above-described flag information.

Further, as in the case of the example shown in FIG. 3a, in a coding unit level 304, the existing syntax element “log 2CbSize”, and the syntax elements “log 2MinBcSize” and “log 2MaxBcSize”, proposed in the present invention, may be described.

“log 2CbSize” denotes the size of the current CU, “log 2MinBcSize” denotes the minimum size of a CU by which template matching-based prediction may be performed, and “log 2MaxBcSize” denotes the maximum size of the CU by which template matching-based prediction may be performed. “log 2MaxBcSize” may be acquired through the syntax element “log 2_min_bc_size_minus2” 302 and the syntax element “log 2_diff_max_min_bc_size” 303, which are described in high-level syntax.

According to the range condition 305, when the size of the current CU is equal to or greater than the minimum size of the CU and is less than or equal to the maximum size, by which template matching-based prediction may be performed, flag information indicating that encoding has been performed in a template matching-based prediction mode may be used for the decoding procedure.

According to an embodiment of the present invention, the minimum and maximum sizes of the CU, by which template matching-based predictive encoding may be performed, are described in high-level syntax such as a picture parameter or a slice segment header. Therefore, when the size of the CU to be encoded/decoded is the size by which template matching-based prediction can be performed (when the range condition is satisfied), template matching-based prediction may be performed on a per-CU basis using the syntax element “intra_bc_flag” 306.

FIG. 3b is a block diagram showing a detailed configuration for determining the size of a CU in the template matching prediction unit.

The template matching prediction unit may include a template CU size parameter parsing unit 350, a template CU size determining unit 360, and a template CU flag parsing unit 370, and may describe the size information of the CU, coded based on template matching, thus minimizing the description of flag bits for individual blocks.

When some CUs of an arbitrary picture are coded based on template matching, information about the minimum and maximum sizes of the CUs, by which a template matching-based prediction mode may be performed, is described in the high-level syntax.

The template CU size parameter parsing unit 350 may decode the information about the minimum and maximum sizes of the CUs.

The template CU size determining unit 360 may determine the minimum and maximum sizes of CUs required to be encoded in a template matching-based prediction mode within a picture, a slice, or a slice segment, based on the information decoded by the template CU size parameter parsing unit 350. Here, the difference value between the maximum and minimum sizes of CUs may be used.

The template CU flag parsing unit 370 may parse flag information that indicates for each block whether CUs have been encoded in a template matching-based prediction mode, only when the size of each CU to be decoded is the allowable size enabling template matching-based prediction (i.e. when the range condition is satisfied).

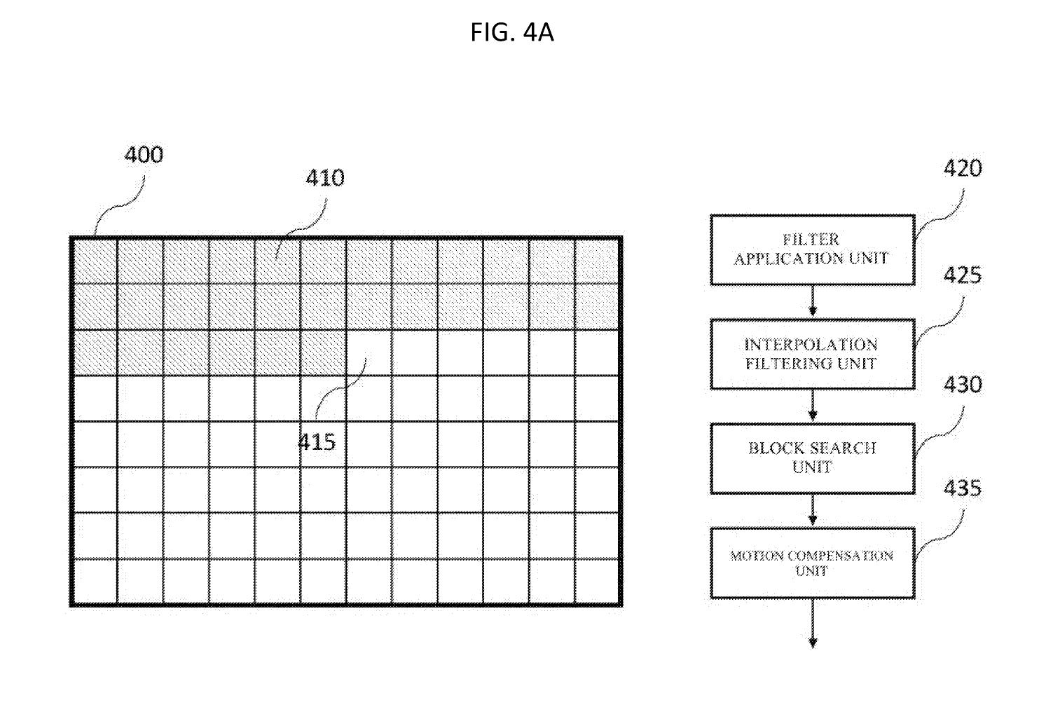

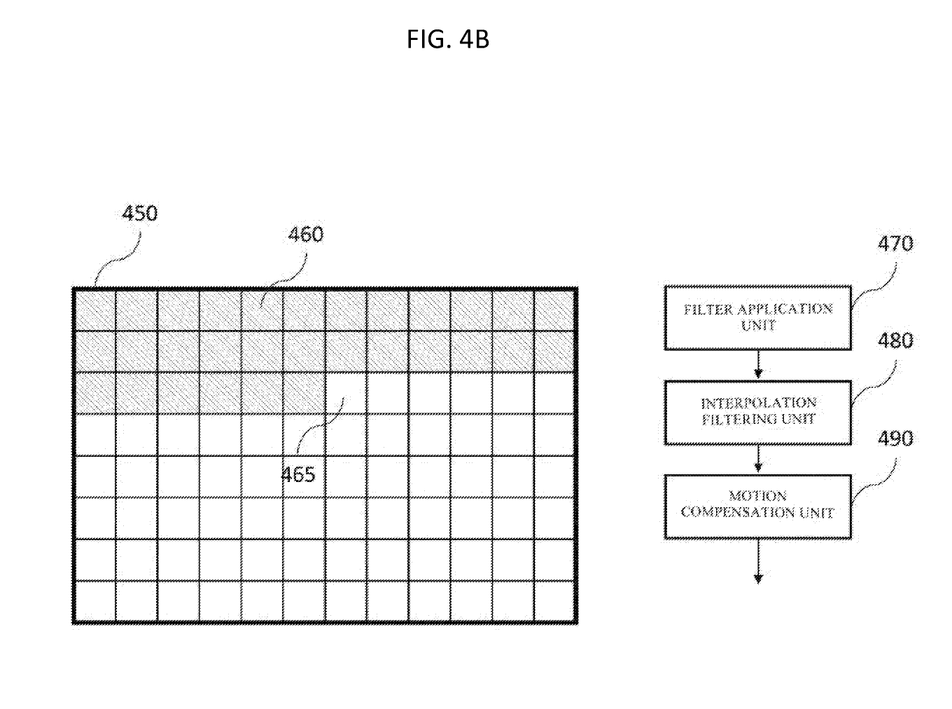

FIG. 4a is a block diagram showing the detailed configuration of a video encoding apparatus for performing encoding in a template matching-based prediction mode.

The template matching prediction unit may include a filter application unit 420, an interpolation filtering unit 425, a block search unit 430, and a motion compensation unit 435, and may reduce an error rate for a previously encoded area when coding based on template matching is performed.

Referring to FIG. 4a, template matching-based predictive encoding for the current block 415 is performed with reference to a previously encoded area 410 in a picture, a slice or a slice segment 400.

The filter application unit 420 performs filtering to minimize errors in the previously encoded area 410 in a picture, a slice or a slice segment. For example, a low-delay filter, a deblocking filter, an adaptive sample offset, or the like may be used.

The interpolation filtering unit 425 performs interpolation to perform a more precise search when template matching-based prediction is performed.

The block search unit 430 searches for the block that is most similar to the current block to be encoded in an interpolated area, and the motion compensation unit 435 generates a predicted value for the found block via template matching.

FIG. 4b is a block diagram showing the detailed configuration of a video decoding apparatus for performing decoding in a template matching-based prediction mode.

The template matching prediction unit may include a filter application unit 470, an interpolation filtering unit 480, and a motion compensation unit 490, may reduce an error rate for a previously decoded area when template matching-based coding is performed, and may execute a template matching-based prediction mode with reference to an area motion-compensated for by the above components.

Referring to FIG. 4b, template matching-based predictive decoding on the current block 465 is performed with reference to a previously decoded area 460 in a picture, a slice or a slice segment 450.

The filter application unit 470 performs filtering to minimize errors in the previously decoded area 460 in a picture, a slice or a slice segment. For example, a low-delay filter, a deblocking filter, or a sample adaptive offset may be used.

The interpolation filtering unit 480 performs interpolation on the previously decoded area 460 to perform template matching-based motion compensation, and the motion compensation unit 490 generates a predicted value from the position information of a received block vector.

That is, the motion compensation unit may generate a template matching-based predicted signal based on a block vector, which is the position information of a region corresponding to the current CU in the previously decoded area.

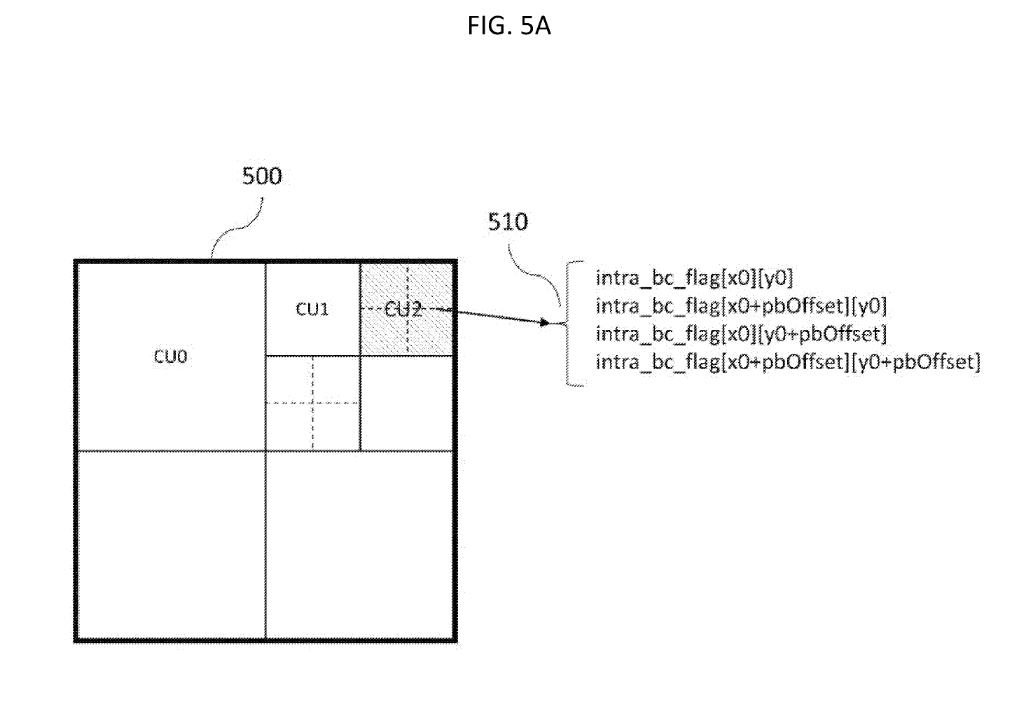

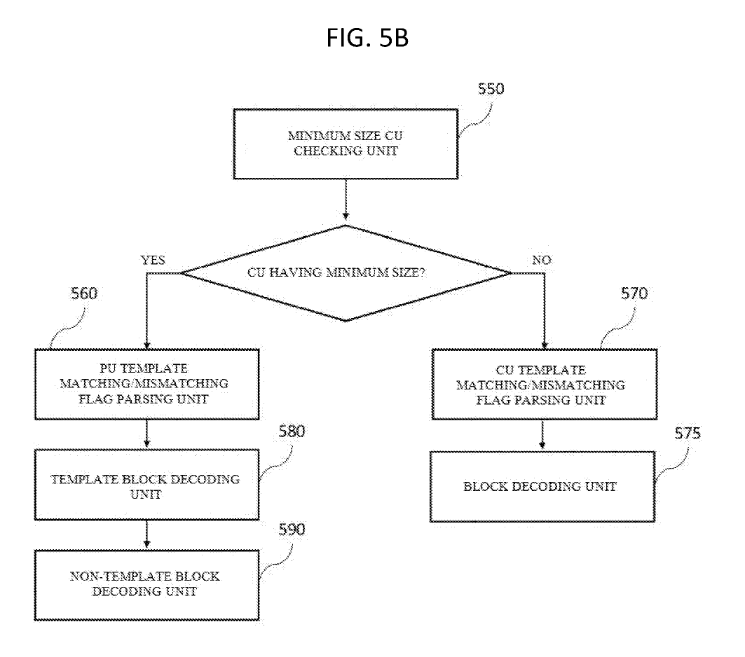

FIG. 5a is a diagram illustrating syntax elements related to whether to use template matching when the size of the CU is equal to the minimum size thereof.

The CU in a picture, slice or slice segment 500 to be encoded/decoded may have flag information indicating whether to perform template matching-based predictive encoding. Such flag information may be described for each CU.

However, when the size of the current CU is equal to the minimum size of the CU, flag information 510 may indicate whether each Prediction Unit (PU) in the current CU has been encoded in a template matching-based prediction mode.

Further, when the size of the current CU is equal to the minimum size of the CU, a predicted signal for each Prediction Unit (PU) in the current CU may be selectively generated by at least one of the template matching prediction unit, the inter-prediction unit, and the intra-prediction unit. That is, for the PU, intra prediction, inter prediction, or template matching-based prediction may be selectively applied. In addition, the inter-prediction unit may generate an inter prediction-based predicted signal for the current CU, based on a motion vector and a reference image for the current CU, and the intra-prediction unit may generate an intra-prediction-based predicted signal for the current CU based on encoding information about a neighboring region spatially adjacent to the current CU.

FIG. 5b is a diagram showing in brief the operation of a video decoding apparatus for performing decoding on each CU or PU depending on the size of the CU.

Referring to FIG. 5b, the video decoding apparatus may include a minimum size CU checking unit 550, a PU template matching/mismatching flag parsing unit 560, a CU template matching/mismatching flag parsing unit 570, a block decoding unit 575, a template block decoding unit 580, and a non-template block decoding unit 590, and may perform template matching-based encoding or non-template matching-based encoding depending on the size of the CU.

The minimum size CU checking unit 550 may check whether the size of the current CU is equal to the minimum size of the CU.

When the size of the current CU desired to be coded is different from the minimum size of the CU, flag information indicating whether to perform template matching-based coding for each CU may be parsed by the CU template matching/mismatching flag parsing unit 570.

In this case, the block decoding unit 575 may perform template matching-based decoding or non-template matching-based decoding on each CU, depending on the flag information that indicates whether each CU has been encoded in a template matching-based prediction mode.

If the size of the current CU desired to be coded is equal to the minimum size thereof, flag information indicating whether to perform template matching-based coding for each PU may be parsed by the PU template matching/mismatching flag parsing unit 560.

In this case, the template block decoding unit 580 may perform template matching-based predictive decoding on the PUs, encoded in the template matching-based prediction mode in the current CU according to a z-scan order, and the non-template block decoding unit 590, such as the intra-prediction unit or the inter-prediction unit, may perform predictive decoding on the remaining PUs, encoded in a non-template matching-based prediction mode, according to the z-scan order. Here, some PUs and the remaining PUs may be determined based on the parsed flag information.

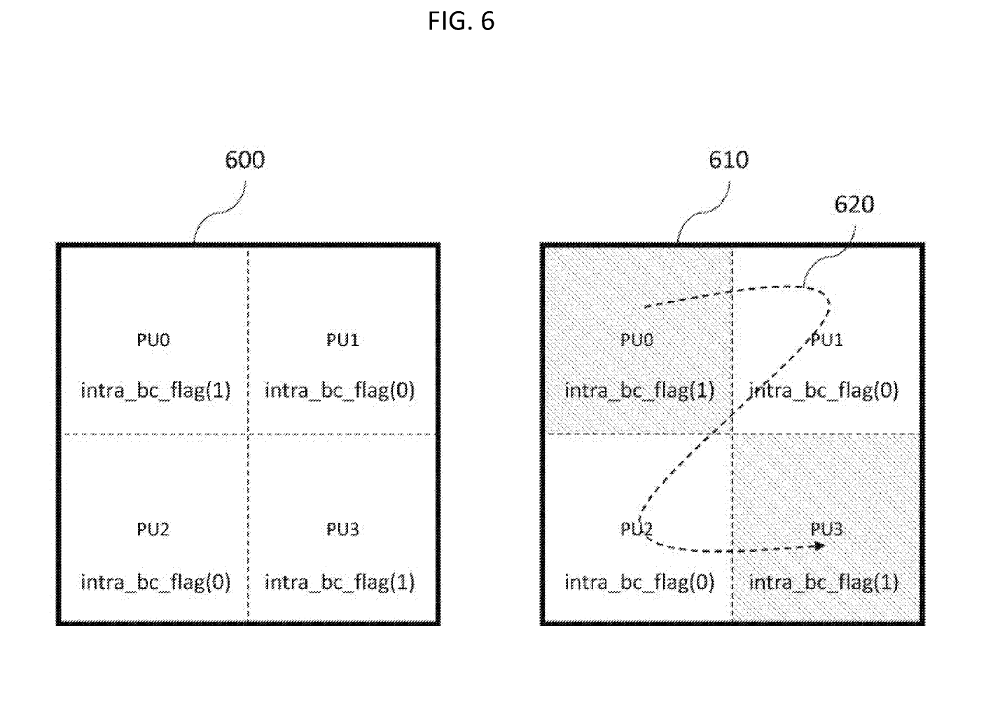

Further, FIG. 6 is a diagram illustrating an example in which, when the size of a CU is equal to the minimum size thereof, PUs encoded in a template matching-based prediction mode are decoded first, among a plurality of PUs in the CU.

Referring to FIG. 6, when the size of the current CU 600 to be decoded is equal to the minimum size of the CU, flag information intra_bc_flag indicating whether to perform template matching-based encoding may be described for each PU.

When the current CU 610 is partitioned into four Prediction Blocks (PUs), prediction blocks having flag information (intra_bc_flag) of ‘1’, among a plurality of prediction blocks, may be decoded in a template matching-based prediction mode according to a z-scan order 620, and then prediction blocks having flag information (intra_bc_flag) of ‘0’ may be decoded in a non-template matching-based prediction mode according to the z-scan order 620.

That is, the above-described template matching prediction unit may determine whether to generate a template matching-based predictive signal for each PU according to the z-scan order, and may generate, for each PU, predicted signals for some of the PUs in the current CU.

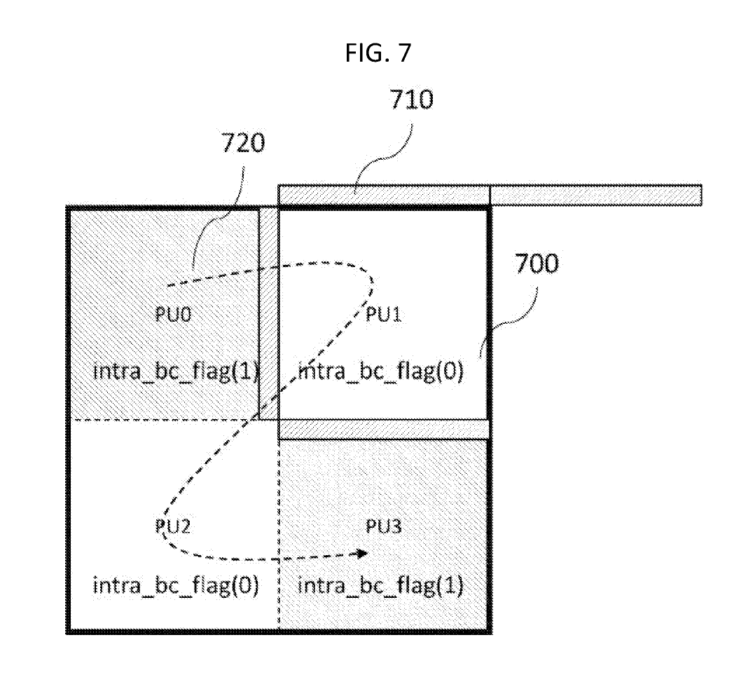

FIG. 7 is a diagram illustrating an example in which a PU encoded in an intra-prediction mode is decoded with reference to an area previously decoded in the template matching-based prediction mode in the CU shown in FIG. 6.

Referring to FIG. 7, when information about whether to perform template matching for each PU in the current CU having a minimum size is described in the form of flag information (intra_bc_flag), the some PUs (PU0, PU3) in the current CU may be decoded in the template matching-based prediction mode. Thereafter, the remaining PUs (PU1, PU3) in the CU may be decoded in the existing intra-prediction or inter-prediction mode. The generation of predicted signals for respective PUs may be performed on a per-PU basis according to a z-scan order 720.

In particular, when a predetermined PU 700 is decoded in an intra-prediction mode, a reference area 710 including an area (shaded area) previously decoded in the template matching-based prediction mode may be referred to. That is, the above-described intra-prediction unit may generate an intra prediction-based predicted signal, based on the area previously decoded by the template matching prediction unit in the corresponding CU.

The video decoding apparatus according to the embodiment of the present invention that has been described includes a predetermined condition related to the size of the current CU, so that the number of related bits that are transmitted is suitably controlled, thus optimizing encoding/decoding efficiency.

Meanwhile, the video decoding apparatus according to another embodiment of the present invention may include a template matching prediction unit.

The template matching prediction unit may determine whether to perform a template matching-based prediction mode on a plurality of CTUs that are spatially adjacent to each other using region flag information for the CTUs.

Further, the template matching prediction unit may determine whether to generate template matching-based predicted signals, using flag information that indicates whether each CU in the CTU determined to perform the template matching-based prediction mode has been encoded in the template matching-based prediction mode.

More specifically, when it is determined to generate the corresponding predicted signals, the template matching prediction unit may generate template matching-based predicted signals from a previously decoded area present in any one of a picture, a slice and a slice segment that includes each CU.

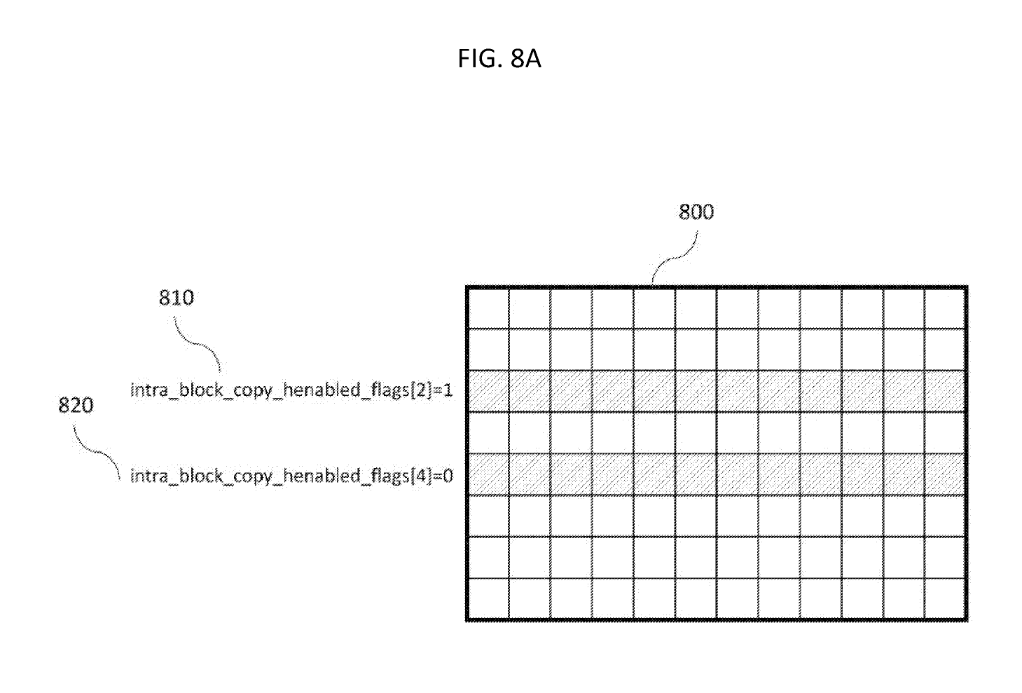

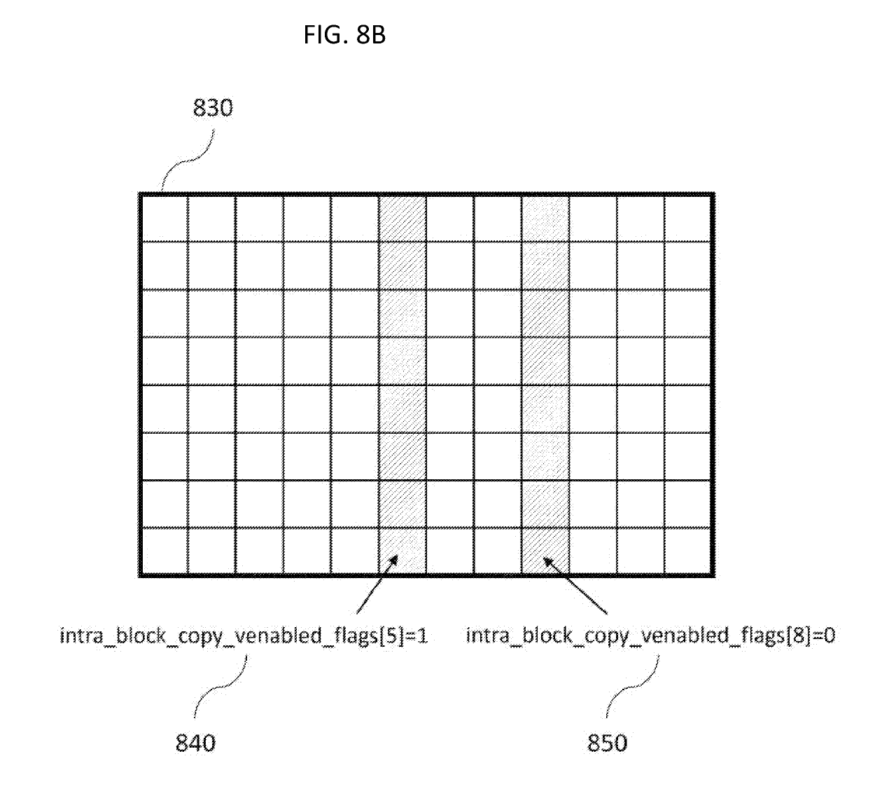

Furthermore, the template matching prediction unit may determine whether to perform a template matching-based prediction mode for each row or column of a CTU, and this operation will be described below with reference to FIGS. 8a and 8b.

FIG. 8a is a diagram illustrating a structure for describing whether to perform template matching-based predictive decoding for each row of a CTU.

Referring to FIG. 8a, pieces of region flag information intra_block_copy_henabled_flag 810 and 820 indicating whether to perform a template matching-based prediction mode for each row of the CTU present in a picture, a slice or a slice segment 800 are described.

For example, in the case of all CUs in a CTU in a second row, in which the value of the intra_block_copy_henabled_flag is ‘1’, flag information indicating whether to perform template matching-based predictive decoding may be additionally described for each CU.

In contrast, in the case of all CUs in a CTU in a fourth row, in which the value of intra_block_copy_henabled_flag is ‘0’, flag information indicating whether to perform template matching-based predictive decoding is not described.

FIG. 8b is a diagram illustrating a structure for describing whether to perform template matching-based predictive decoding for each column of a CTU.

Referring to FIG. 8b, pieces of region flag information intra_block_copy_venabled_flag 840 and 850 indicating whether to perform a template matching-based prediction mode for each column of a CTU in a picture, a slice or a slice segment 830 are described.

For example, in the case of all CUs in a CTU in a fifth column, in which the value of intra_block_copy_venabled_flag is ‘1’, flag information indicating whether to perform template matching-based predictive decoding is additionally described for each CU.

In contrast, in the case of all CUs in a CTU in an eighth column, in which the value of intra_block_copy_henabled_flag is ‘0’, flag information indicating whether to perform template matching-based predictive decoding is not described.

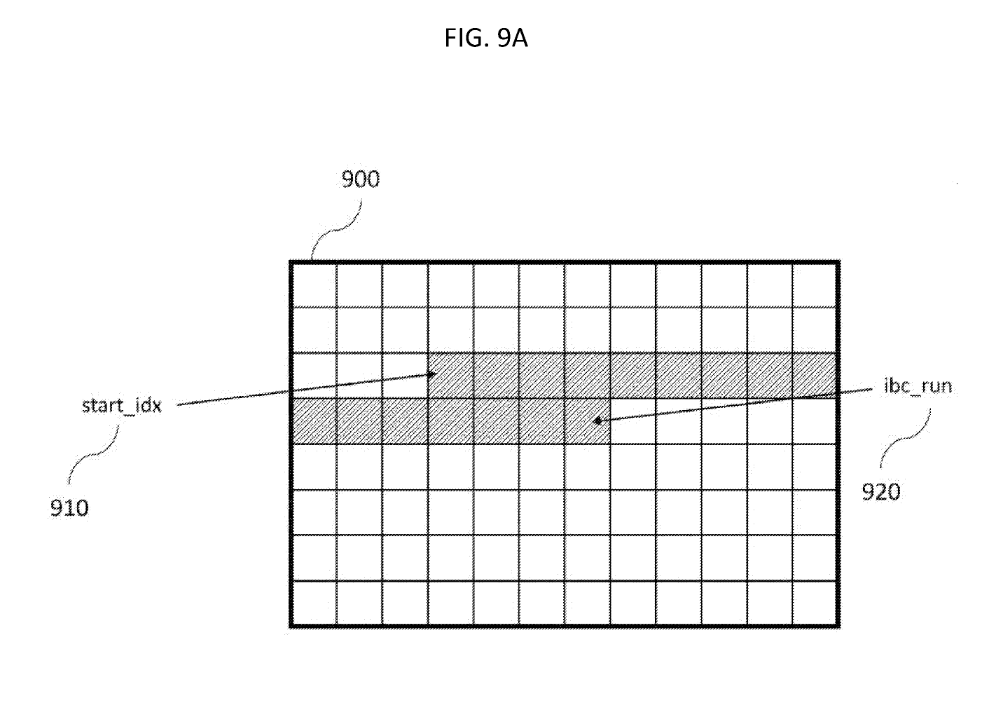

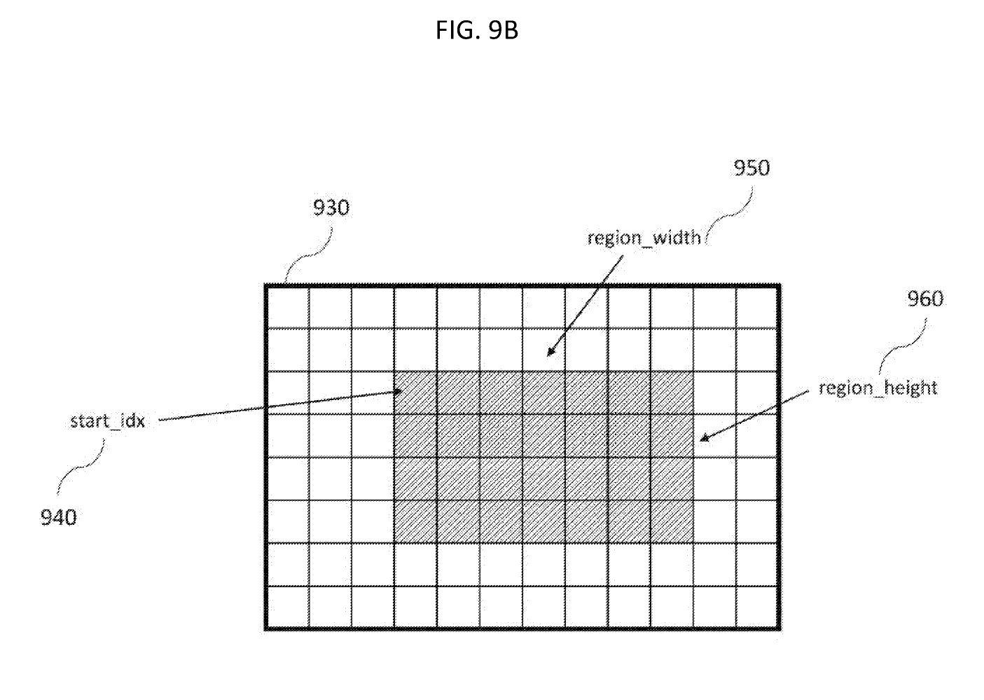

Further, the template matching prediction unit may determine whether to perform a template matching-based prediction mode, based on index information about the position of a predetermined CTU and information about the number of consecutive CTUs ranging from the predetermined CTU as a start point, and this operation will be described below with reference to FIG. 9a.

FIG. 9a is a diagram illustrating a structure for describing whether to perform template matching-based predictive decoding based on the start position of CTUs and the number of consecutive CTUs.

Referring to FIG. 9a, when a partial region of a picture, slice or slice segment 900 is encoded in a template matching-based prediction mode, both the index information (start_idx) 910 about the position of a predetermined CTU and information about the number of consecutive CTUs (number information, ibc_run) 920 ranging from the position as a start point may be simultaneously described so as to indicate the partial region.

In this way, in the case of the region encoded in the template matching-based prediction mode, flag information indicating whether to perform decoding in a template matching-based prediction mode for each CU may be additionally described in the corresponding region by means of the index information 910 and the number information 920.

In addition, the template matching prediction unit may determine whether to perform a template matching-based prediction mode, based on both index information about the position of a predetermined CTU and information about the number of CTUs located on the horizontal side (width) and vertical side (height) side of a rectangle having the predetermined CTU as a vertex, and this operation will be described with reference to FIG. 9b.

FIG. 9b is a diagram illustrating a structure for describing whether to perform template matching-based predictive decoding based on an arbitrary rectangular region composed of CTUs.

Referring to FIG. 9b, when a partial rectangular region in a picture, a slice or a slice segment 930 is encoded in a template matching-based prediction mode, index information (start_idx) 940 about a CTU located at the top-left position of a rectangular region and the number information (region_width, region_height) 950 and 960 about the numbers of CTUs located on the horizontal side and the vertical side of the rectangular region may be simultaneously described so as to indicate the rectangular region.

In this way, in the case of a rectangular region encoded in a template matching-based prediction mode, flag information indicating whether to perform decoding in a template matching-based prediction mode may be additionally described for each CU in the corresponding region.

In addition, as described above with reference to FIGS. 4a and 4b, the template matching prediction unit may include a filter application unit, an interpolation filtering unit, and a motion compensation unit.

The filter application unit may perform filtering on a previously decoded area, and the interpolation filtering unit may perform interpolation on the previously decoded area.

The motion compensation unit may generate a template matching-based predicted signal on a block vector, which is position information of the region that corresponds to each CU in the previously decoded area of the current picture.

The video decoding apparatus according to another embodiment of the present invention, which has been described, may be usefully exploited to improve the coding efficiency in the field of screen content in which a subtitle (text) area and a video area are separated, by utilizing region flag information.

Meanwhile, the video decoding apparatus according to a further embodiment of the present invention may include a template matching prediction unit.

The template matching prediction unit may determine whether to generate a template matching-based predicted signal for the current CU using skip flag information.

Here, the skip flag information may be described and used in syntax elements when any one of a picture, a slice, and a slice segment that includes the current CU, is intra coded, the current CU is encoded in a template matching-based prediction mode, a block vector for the current CU is identical to a block vector for a neighboring region spatially adjacent to the current CU, and a residual signal for the current CU is absent.

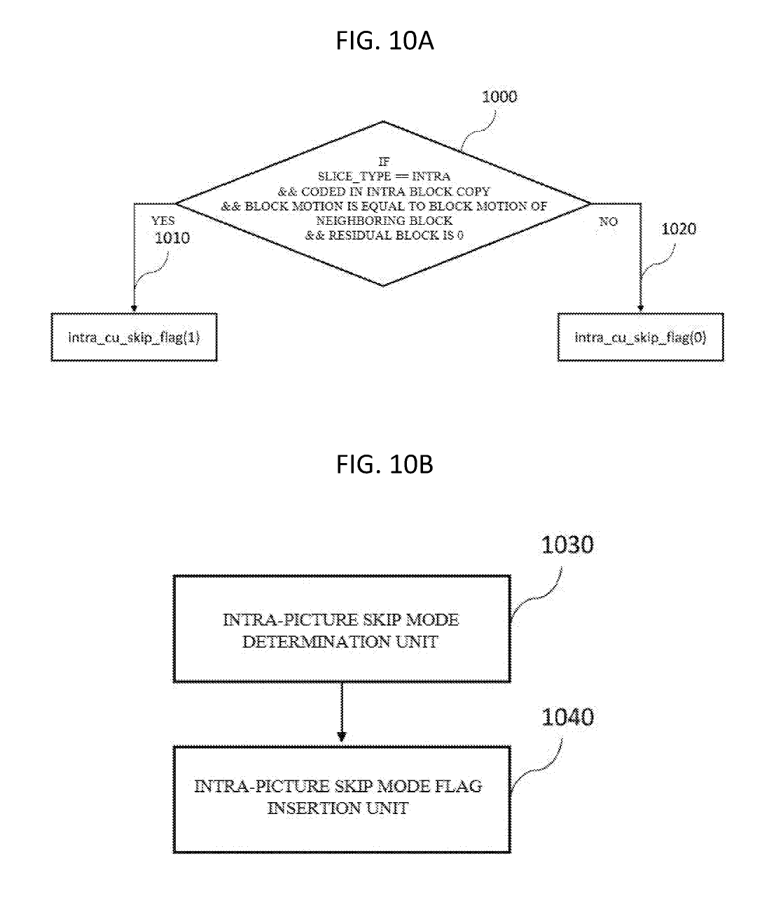

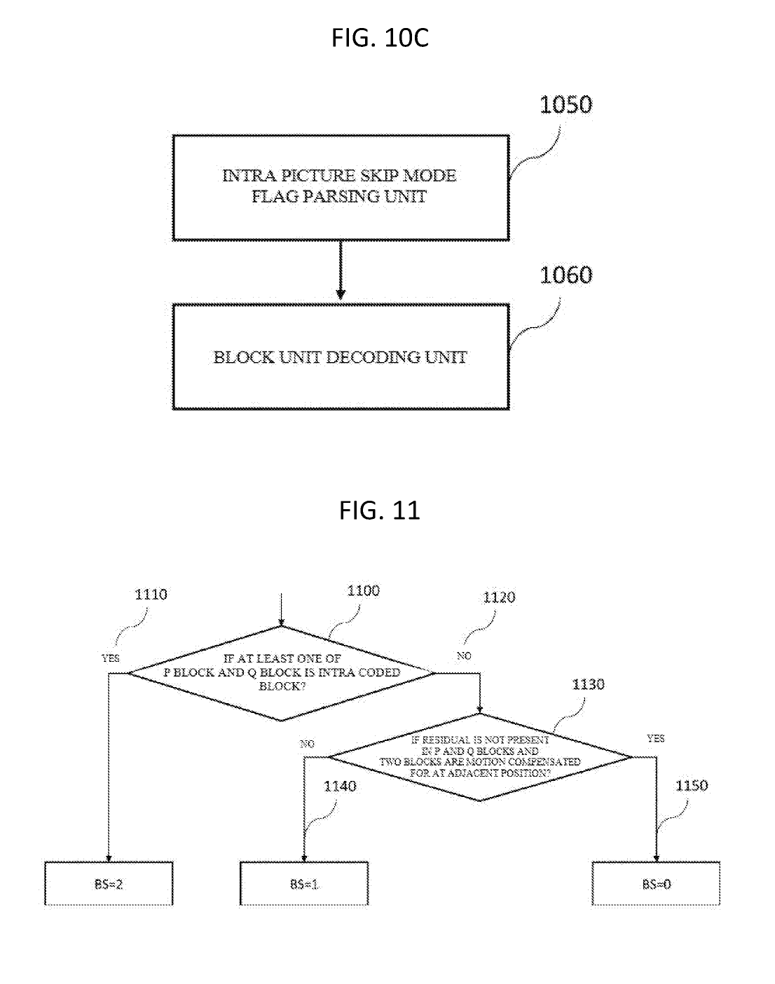

In relation to skip flag information, a description will be made below with reference to FIGS. 10a to 10c.

FIG. 10a is a diagram illustrating an algorithm for encoding the current CU in a skip mode.

Referring to FIG. 10a, when the following conditions 1000 are satisfied, skip flag information indicating that the current CU is encoded in a skip mode may be generated.

The conditions 1000 may include items related to whether a slice including the current CU has been intra coded, whether the current CU has been encoded in a template matching-based prediction mode (intra block copy: IBC), whether a block vector for the current CU is identical to a block vector for a neighboring region spatially adjacent to the current CU, and whether a residual signal for the current CU is absent.

When all of the conditions 10000 are satisfied (1010), skip flag information (intra_cu_skip_flag=1), indicating that the current CU to be encoded in an intra picture is set to a skip mode, may be generated, and thus the number of syntax elements for the current CU may be minimally signaled.

When at least one of the conditions 1000 is not satisfied (1020), skip flag information (intra_cu_skip_flag=0), indicating that the current CU to be encoded is not set to a skip mode, may be generated, and thus the syntax elements for the current CU may be described as a block vector, a differential coefficient, block partition information, etc., as in the case of existing schemes.

FIG. 10b is a block diagram showing a detailed configuration for encoding the current CU in a skip mode.

The template matching prediction unit of the video encoding apparatus may include an intra-picture skip mode determination unit 1030 and an intra-picture skip mode flag insertion unit 1040, and may encode some intra-picture CUs in a skip mode.

The intra-picture skip mode determination unit 1030 may determine whether the current CU, which is intra-picture coded, satisfies the condition of the skip mode.

If the encoding of the current CU in the skip mode is determined to be optimal from the standpoint of rate-distortion optimization, the intra picture skip mode flag insertion unit 1040 may insert skip flag information indicating that the current CU has been encoded in the skip mode.

If the encoding of the current CU in the skip mode is determined not to be optimal from the standpoint of rate-distortion optimization, the intra picture skip mode flag insertion unit 1040 may insert skip flag information indicating that the current CU has not been encoded in a skip mode.

FIG. 10c is a block diagram showing a detailed configuration for decoding the current CU in a skip mode.

The template matching prediction unit of the video decoding apparatus may include an intra picture skip mode flag parsing unit 1050 and a block unit decoding unit 1060, and may selectively decode a CU which is coded in an intra-picture skip mode or an existing prediction mode.

The intra-picture skip mode flag parsing unit 1050 may parse the bits of skip flag information for each CU. The skip flag information is information indicating whether each intra-picture CU has been coded in a skip mode.

When the current CU has been coded in the intra-picture skip mode, the block unit decoding unit 1060 may decode the current CU depending on the skip mode.

When the current CU has not been coded in the intra-picture skip mode, the block unit decoding unit 1060 may reconstruct an image by performing a prediction mode based on existing intra prediction or inter prediction.

In this way, the skip mode used in the existing inter prediction-based prediction mode is applied to the template matching-based prediction mode in an intra picture, thus improving video encoding/decoding efficiency.

Meanwhile, the video encoding apparatus according to a further embodiment of the present invention may include a template matching prediction unit.

The template matching prediction unit may determine whether to generate a template matching-based predicted signal for the current CU, using flag information indicating whether the current CU has been coded in the template matching-based prediction mode.

Further, the template matching prediction unit may set a boundary strength for deblocking filtering at an edge boundary in the current CU.

In this case, depending on prediction modes, residual signals, and block vectors of the current CU and each neighboring CU, which is adjacent to the current CU based on an edge boundary, the boundary strength between the current CU and each neighboring CU may be differently set.

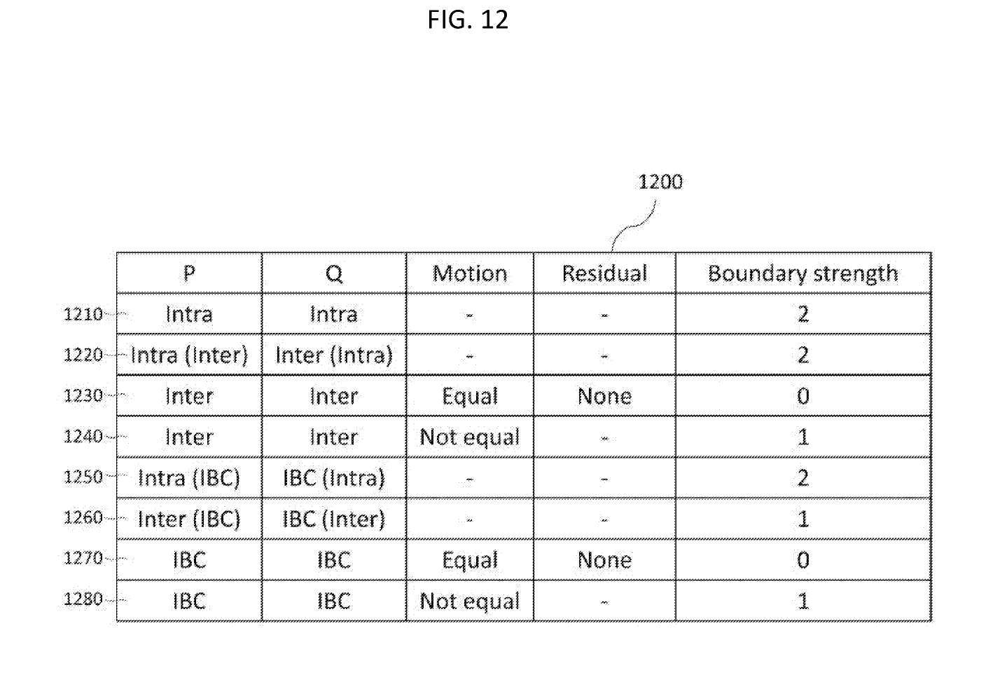

The setting of boundary strength will be described below with reference to FIGS. 11 and 12.

FIG. 11 is a diagram showing an algorithm for setting the boundary strength to perform deblocking filtering at an edge boundary according to an example.

Referring to FIG. 11, when a block is coded via intra prediction, inter prediction, or template matching-based prediction, deblocking filtering is performed on the edge boundary of the block. Filtering at the edge boundary of the block is performed using a boundary strength (Bs) value calculated in FIG. 11.

Assuming that a block located on the left or upper side of a block boundary is P and a block located on the right or lower side of the block boundary is Q, coding modes for the two blocks are first determined (1100). When at least one of the P and Q blocks is coded through existing intra prediction (1110), the value of the boundary strength is set to 2. Otherwise (1120), whether a differential coefficient other than 0 is not present in both P and Q blocks, and whether two blocks are motion compensated for at an adjacent position, is determined (1130). When the two conditions are satisfied (1150), no discontinuity is present at the boundary of the two blocks, and thus the value of the boundary strength is set to 0. Otherwise (1140), the value of the boundary strength is set to 1.

The calculated boundary strength value is used to determine filtering strength or the like during the procedure for performing deblocking filtering.

FIG. 12 is a diagram showing an algorithm for setting boundary strength to perform deblocking filtering at an edge boundary according to another example.

Referring to FIG. 12, boundary strength is set based on the encoding modes, motion information, presence/absence of differential coefficients, etc. of two blocks P and Q, which are adjacent to each other with respect to an edge boundary.

When both P and Q are encoded based on intra prediction (1210), the value of the boundary strength is set to 2. When P is encoded based on intra prediction and Q is encoded based on inter prediction, or, on the other hand, when P is encoded based on inter prediction and Q is encoded based on intra prediction (1220), the value of the boundary strength is set to 2.

When P and Q blocks are encoded based inter prediction, and differential coefficients other than 0 are not present in the two block modes, and when the motion vectors for two blocks are equal to each other in integer pixel units (1230), the value of the boundary strength is set to 0. When the P and Q blocks are encoded based on inter prediction and motion vectors for the two blocks are not equal to each other in integer pixel units (1240), the value of the boundary strength is set to 1.

When the P block is encoded based on intra prediction and the Q block is encoded based on Intra block copy (IBC), which is a template matching-based encoding mode, or on the other hand, when the P block is encoded based on IBC and the Q block is encoded based on existing intra prediction (1250), the value of the boundary strength at the block boundary is set to 2.

When the P block is encoded based on inter prediction and the Q block is encoded based on IBC, or, on the other hand, when the P block is encoded based on IBC and the Q block is encoded based on inter prediction (1260), the value of the boundary strength at the block boundary is set to 1.

When both the P and Q blocks are encoded based on IBC, and differential coefficients other than 0 are not present in either block, and when block vectors for the two blocks are equal to each other in integer pixel units (1270), the value of the boundary strength at the edge boundary of the two blocks is set to 0.

When both the P and Q blocks are encoded based on IBC, and block vectors for the two blocks are not equal to each other in integer pixel units (1280), the value of the boundary strength at the edge boundary of the blocks is set to ‘1’.

In this way, the boundary strength between the current CU and each neighboring CU is set differently depending on the prediction mode, the residual signal, and block vectors, thus enabling deblocking filtering to be more efficiently performed.

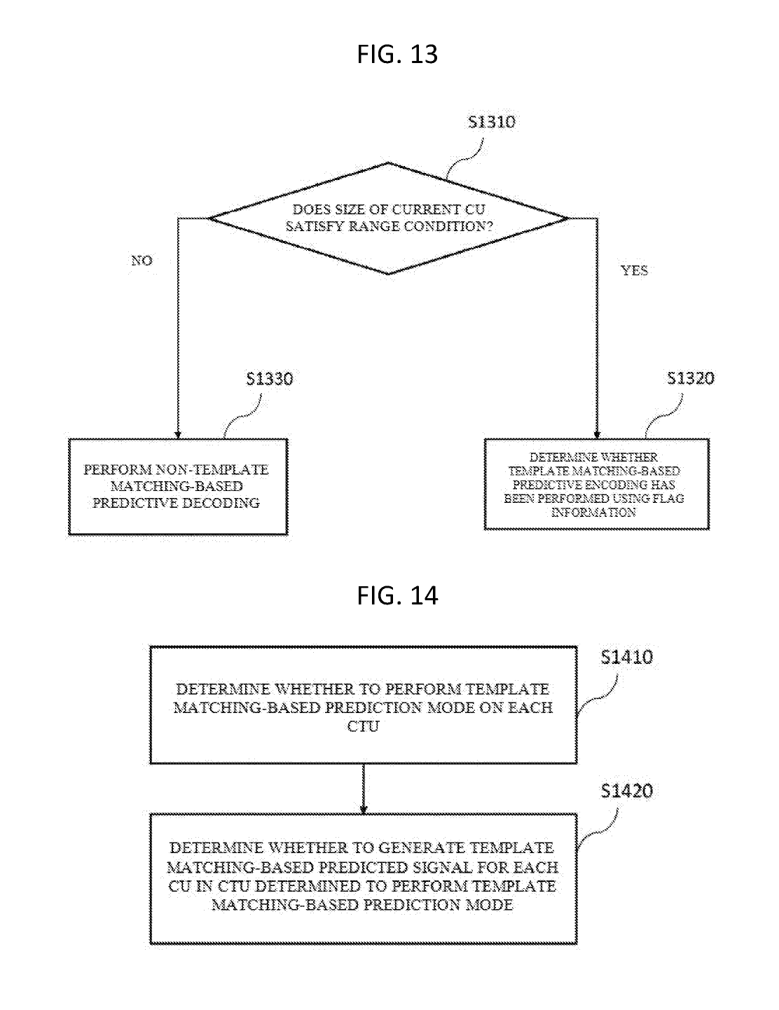

Hereinafter, a video decoding method will be described with reference to FIGS. 13 to 16. For this, the above-described video decoding apparatus has been utilized, but the present invention is not limited thereto. However, for the convenience of description, a method for decoding video using the video decoding apparatus will be described below.

The video decoding method according to an embodiment of the present invention may be performed using the following steps, as shown in FIG. 13. FIG. 13 is a flowchart showing a video decoding method according to an embodiment of the present invention.

First, whether the size of the current CU satisfies a range condition for the minimum and maximum sizes of CUs to be encoded in a template matching-based prediction mode is determined (S1310).

When the above-described range condition is satisfied, whether to generate a template matching-based predicted signal for the current CU is determined using flag information indicating whether the current CU has been encoded in a template matching-based prediction mode (S1320).

When the above-described condition is not satisfied, non-template matching-based predictive decoding is performed on the current CU (S1330).

Further, a video decoding method according to another embodiment of the present invention may be performed using the following steps, as shown in FIG. 14. FIG. 14 is a flowchart showing a video decoding method according to another embodiment of the present invention.

First, whether to perform a template matching-based prediction mode on each CTU is determined using region flag information for a plurality of CTUs that are spatially adjacent to each other (S1410).

Next, whether to generate a template matching-based predicted signal is determined using additional flag information that indicates whether each CU in the CTU determined to perform the template matching-based prediction mode has been encoded in the template matching-based prediction mode (S1420).

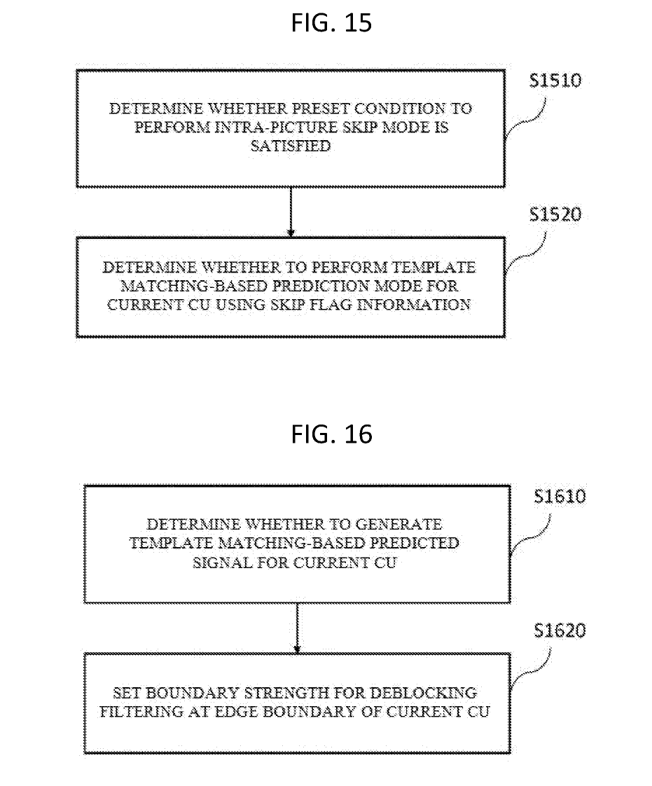

Further, the video decoding method according to a further embodiment of the present invention may be performed using the following steps, as shown in FIG. 15. FIG. 15 is a flowchart showing a video decoding method according to a further embodiment of the present invention.

First, it is determined whether any one of a picture, a slice, and a slice segment that includes the current CU is intra coded, whether the current CU has been encoded in a template matching-based prediction mode, whether a block vector for the current CU is identical to a block vector for a neighboring region spatially adjacent to the current CU, and whether a residual signal for the current CU is absent (S1510).

When all of these conditions are satisfied, whether to generate a template matching-based predicted signal for an intra-picture current CU is determined using skip flag information (S1520).

Furthermore, a video decoding method according to still another embodiment of the present invention may be performed using the following steps, as shown in FIG. 16. FIG. 16 is a flowchart showing a video decoding method according to still another embodiment of the present invention.

First, whether to generate a template matching-based predicted signal for the current CU is determined using flag information indicating whether the current CU has been encoded in a template matching-based prediction mode (S1610).

Then, a boundary strength for deblocking filtering at an edge boundary of the current CU is set (S1620).

Here, depending on prediction modes, residual signals, and block vectors of the current CU and each neighboring CU, which is adjacent to the current CU with respect to the edge boundary, the boundary strength between the current CU and the neighboring CU may be differently set.

Meanwhile, respective components shown in FIGS. 1, 3b, 4a, 4b, 5b, 10b, and 10c may be implemented as kinds of ‘modules’. The term ‘module’ means a software component or a hardware component, such as a Field Programmable Gate Array (FPGA) or an Application Specific Integrated Circuit (ASIC), and respective modules perform some functions. However, such a module does not have a meaning limited to software or hardware. Such a module may be implemented to be present in an addressable storage medium or configured to execute one or more processors. The functions provided by components and modules may be combined into fewer components and modules, or may be further separated into additional components and modules.

Although the apparatus and method according to the present invention have been described in relation to specific embodiments, all or some of the components or operations thereof may be implemented using a computer system having general-purpose hardware architecture.

Furthermore, the embodiments of the present invention may also be implemented in the form of storage media including instructions that are executed by a computer, such as program modules executed by the computer. The computer-readable media may be arbitrary available media that can be accessed by the computer, and may include all of volatile and nonvolatile media and removable and non-removable media. Further, the computer-readable media may include all of computer storage media and communication media. The computer-storage media include all of volatile and nonvolatile media and removable and non-removable media, which are implemented using any method or technology for storing information, such as computer-readable instructions, data structures, program modules or additional data. The communication media typically include transmission media for computer-readable instructions, data structures, program modules or additional data for modulated data signals, such as carrier waves, or additional transmission mechanisms, and include arbitrary information delivery media.

The description of the present invention is intended for illustration, and those skilled in the art will appreciate that the present invention can be easily modified in other detailed forms without changing the technical spirit or essential features of the present invention. Therefore, the above-described embodiments should be understood as being exemplary rather than restrictive. For example, each component described as a single component may be distributed and practiced, and similarly, components described as being distributed may also be practiced in an integrated form.

The scope of the present invention should be defined by the accompanying claims rather than by the detailed description, and all changes or modifications derived from the meanings and scopes of the claims and equivalents thereof should be construed as being included in the scope of the present invention.

1. A video decoding apparatus, comprising:
a template matching prediction unit for determining whether to generate a template matching-based predicted signal for a current Coding Unit (CU) using flag information that indicates whether the current CU has been encoded in a template matching-based prediction mode,
wherein the flag information is used when a size of the current CU satisfies a range condition for minimum and maximum sizes of each CU to be encoded in the prediction mode.

2. The video decoding apparatus of claim 1, wherein the template matching prediction unit generates the template matching-based predicted signal from an area previously decoded in any one of a picture, a slice, and a slice segment that includes the current CU.

3. The video decoding apparatus of claim 2, wherein the template matching prediction unit comprises:
a filter application unit for performing filtering on the previously decoded area;
an interpolation filtering unit for performing interpolation on the previously decoded area; and
a motion compensation unit for generating the template matching-based predicted signal, based on a block vector which is position information of a region corresponding to the current CU in the previously decoded area.

4. The video decoding apparatus of claim 1, wherein the information about the range condition is included in a sequence parameter set for a sequence that includes the current CU, a picture parameter set for a picture group or a picture that includes the current CU, or a slice header for a slice or a slice segment that includes the current CU.

5. The video decoding apparatus of claim 1, wherein the flag information is used when the size of the current CU satisfies a range condition for minimum and maximum sizes of a slice that includes the current CU.

6. The video decoding apparatus of claim 1, wherein when the size of the current CU is equal to the minimum size of the CU, the flag information indicates whether each of Prediction Units (PUs) in the current CU has been encoded in the prediction mode.

7. The video decoding apparatus of claim 6, wherein the template matching prediction unit determines whether to generate template matching-based predicted signals for respective PUs according to a z-scan order, and generates predicted signals for a part of the PUs, for each PU in the current CU.

8. The video decoding apparatus of claim 1, further comprising:
an inter-prediction unit for generating an inter prediction-based predicted signal for the current CU, based on a motion vector and a reference image for the current CU; and
a intra-prediction unit for generating an intra prediction-based predicted signal for the current CU, based on encoding information about a neighboring region spatially adjacent to the current CU,
wherein, when the size of the current CU is equal to the minimum size of the CU, predicted signals for respective PUs in the current CU are selectively generated by at least one of the template matching prediction unit, the inter-prediction unit, and the intra-prediction unit.

9. The video decoding apparatus of claim 8, wherein the intra-prediction unit generates the intra prediction-based predicted signal based on an area previously decoded by the template matching prediction unit in the CU.

10. A video decoding apparatus, comprising:
a template matching prediction unit for determining whether to perform a template matching-based prediction mode on a plurality of Coding Tree Units (CTUs) that are spatially adjacent to each other, using region flag information for the CTUs, and for determining whether to generate a template matching-based predicted signal, using additional flag information that indicates whether each CU in a CTU determined to perform the prediction mode has been encoded in the template matching-based prediction mode.

11. The video decoding apparatus of claim 10, wherein the template matching prediction unit generates the template matching-based predicted signal from an area previously decoded in any one of a picture, a slice, and a slice segment that includes each CU.

12. The video decoding apparatus of claim 11, wherein the template matching prediction unit comprises:
a filter application unit for performing filtering on the previously decoded area;
an interpolation filtering unit for performing interpolation on the previously decoded area; and
a motion compensation unit for generating the template matching-based predicted signal based on a block vector, which is position information of a region corresponding to each CU in the previously decoded area.

13. The video decoding apparatus of claim 10, wherein the template matching prediction unit determines whether to perform the prediction mode for each row or column of the CTU.

14. The video decoding apparatus of claim 10, wherein the template matching prediction unit determines whether to perform the prediction mode, based both on index information about a position of a predetermined CTU and on information about a number of consecutive CTUs ranging from the predetermined CTU as a start point.

15. The video decoding apparatus of claim 10, wherein the template matching prediction unit determines whether to perform the prediction mode, based both on index information about a position of a predetermined CTU and on information about a number of CTUs respectively located on a horizontal side and a vertical side of a rectangle having the predetermined CTU as a vertex.

16. A video decoding apparatus, comprising:
a template matching prediction unit for determining, using skip flag information, whether to generate a template matching-based predicted signal for a current CU,
wherein the skip flag information is used when any one of a picture, a slice, and a slice segment that includes the current CU, is intra coded, when the current CU is encoded in a template matching-based prediction mode, when a block vector for the current CU is identical to a block vector for a neighboring region spatially adjacent to the current CU, and when a residual signal for the current CU is absent.

17. A video decoding apparatus, comprising:
a template matching prediction unit for determining whether to generate a template matching-based predicted signal for a current CU, using flag information indicating whether the current CU has been encoded in a template matching-based prediction mode, and for setting a boundary strength for deblocking filtering at an edge boundary of the current CU,
wherein a boundary strength between the current CU and each neighboring CU adjacent to the current CU with respect to the edge boundary is set differently depending on prediction modes, residual signals, and block vectors for the current CU and the neighboring CU.

18. A video decoding method, comprising:
when a size of a current CU satisfies a range condition for minimum and maximum sizes of each CU to be encoded in a template matching-based prediction mode, determining whether to generate a template matching-based predicted signal for the current CU, using flag information indicating whether the current CU has been encoded in the prediction mode.

19. A video decoding method, comprising:
determining whether to perform a template matching-based prediction mode on a plurality of Coding Tree Units (CTUs) that are spatially adjacent to each other, using region flag information for the CTUs;
determining whether to generate a template matching-based predicted signal, using additional flag information that indicates whether each CU in a CTU determined to perform the prediction mode has been encoded in the template matching-based prediction mode.

20. A video decoding method, comprising:
determining, using skip flag information, whether to generate a template matching-based predicted signal for a current CU when any one of a picture, a slice, and a slice segment that includes the current CU, is intra coded, when the current CU is encoded in a template matching-based prediction mode, when a block vector for the current CU is identical to a block vector for a neighboring region spatially adjacent to the current CU, and when a residual signal for the current CU is absent.

21. A video decoding method, comprising:
determining whether to generate a template matching-based predicted signal for a current CU, using flag information indicating whether the current CU has been encoded in a template matching-based prediction mode; and
setting a boundary strength for deblocking filtering at an edge boundary of the current CU,
wherein a boundary strength between the current CU and each neighboring CU adjacent to the current CU with respect to the edge boundary is set differently depending on prediction modes, residual signals, and block vectors for the current CU and the neighboring CU.
